(19) United States
(12) Patent Application Publication
(10) Pub. No.: US 2026/0087670 A1
(43) Pub. Date: Mar. 26, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventors: Takenobu KIYAMA, Tokyo (JP); Gaku Nakano, Tokyo (JP)

(73) Assignee: NEC Corporation, Tokyo (JP)

(21) Appl. No.: 19/317,215

(22) Filed: Sep. 3, 2025

(30) Foreign Application Priority Data
Sep. 20, 2024 (JP) 2024-163228

(51) Int. Cl. G06T 7/80; G06T 3/40; G06V 10/75

(52) U.S. Cl. CPC G06T 7/80; G06T 3/40; G06V 10/757

(57) ABSTRACT

An information processing apparatus includes a calibration calculation unit that performs first calibration of a camera based on a first feature point position of a planar pattern included in a first image captured by the camera and a second feature point position of the planar pattern on world coordinates, and an output unit that outputs, based on the first calibration, a deformed pattern obtained by deforming the planar pattern in such a way that the deformed pattern appears on a second image captured by the camera as if the camera were facing the planar pattern.

The calibration calculation unit acquires the second image of the deformed pattern captured by the camera, and performs second calibration of the camera based on a third feature point position of the deformed pattern in the second image and a fourth feature point position of the deformed pattern on the world coordinates.

### TECHNICAL FIELD

The present disclosure relates to an information processing apparatus, an information processing method, and a program.

### BACKGROUND ART

There is known a method of capturing an image of a planar pattern in which a position of a feature point on world coordinates is known, and performing camera calibration based on a correspondence between the feature point on the world coordinates and a feature point on a captured image. Z. Y. ZHANG., “A FLEXIBLE NEW TECHNIQUE FOR CAMERA CALIBRATION”, IEEE TRANSACTIONS ON PATTERN ANALYSIS AND MACHINE INTELLIGENCE (VOLUME: 22, ISSUE: 11, NOVEMBER 2000, [Searched on Sep. 12, 2024], Internet <URL:https://ieeexplore.ieee.org/document/888718> discloses a specific calculation method for performing the above-described calibration.

### SUMMARY

An information processing apparatus according to one aspect of the present disclosure includes at least one memory configured to store instructions; and at least one processor configured to execute the instructions to: perform first calibration of a camera based on a first feature point position of a planar pattern included in a first image captured by the camera and a second feature point position of the planar pattern on world coordinates; and output, based on the first calibration, a deformed pattern obtained by deforming the planar pattern in such a way that the deformed pattern appears on a second image captured by the camera as if the camera were facing the planar pattern, wherein the at least one processor is configured to execute the instructions to acquire the second image of the deformed pattern captured by the camera, and to perform second calibration of the camera based on a third feature point position of the deformed pattern in the second image and a fourth feature point position of the deformed pattern on the world coordinates.

An information processing method according to another aspect of the present disclosure, causes an information processing apparatus to execute performing first calibration of a camera based on a first feature point position of a planar pattern included in a first image captured by the camera and a second feature point position of the planar pattern on world coordinates, outputting, based on the first calibration, a deformed pattern obtained by deforming the planar pattern in such a way that the deformed pattern appears on a second image captured by the camera as if the camera were facing the planar pattern, acquiring the second image of the deformed pattern captured by the camera, and performing second calibration of the camera based on a third feature point position of the deformed pattern in the second image and a fourth feature point position of the deformed pattern on the world coordinates.

An information processing program according to a still another aspect of the present disclosure, causes a computer to execute performing first calibration of a camera based on a first feature point position of a planar pattern included in a first image captured by the camera and a second feature point position of the planar pattern on world coordinates, outputting, based on the first calibration, a deformed pattern obtained by deforming the planar pattern in such a way that the deformed pattern appears on a second image captured by the camera as if the camera were facing the planar pattern, acquiring the second image of the deformed pattern captured by the camera, and performing second calibration of the camera based on a third feature point position of the deformed pattern in the second image and a fourth feature point position of the deformed pattern on the world coordinates.

### BRIEF DESCRIPTION OF THE DRAWINGS

FIG. 1 is a diagram illustrating a hardware configuration of an information processing apparatus according to the present disclosure;

FIG. 2 is a diagram illustrating one functional configuration of the information processing apparatus according to the present disclosure;

FIG. 3 is a diagram illustrating processing in an output unit 102 of the information processing apparatus according to the present disclosure;

FIG. 4 is a diagram illustrating a flow of one operation of the information processing apparatus according to the present disclosure;

FIG. 5 is a diagram illustrating a flow of one operation of the information processing apparatus according to the present disclosure;

FIG. 6 is a diagram illustrating a flow of one operation of the information processing apparatus according to the present disclosure;

FIG. 7 is a diagram illustrating a flow of one operation of the information processing apparatus according to the present disclosure;

FIG. 8 is a diagram illustrating a flow of one operation of the information processing apparatus according to the present disclosure;

FIG. 9 is a diagram illustrating a functional configuration of the information processing apparatus according to the present disclosure;

FIG. 10 is a diagram illustrating a flow of one operation of the information processing apparatus according to the present disclosure; and

FIG. 11 is a diagram illustrating a flow of one operation of the information processing apparatus according to the present disclosure.

### EXAMPLE EMBODIMENT

Hereinafter, example embodiments of an information processing apparatus, an information processing method, and a program will be described with reference to the drawings.

### First Example Embodiment

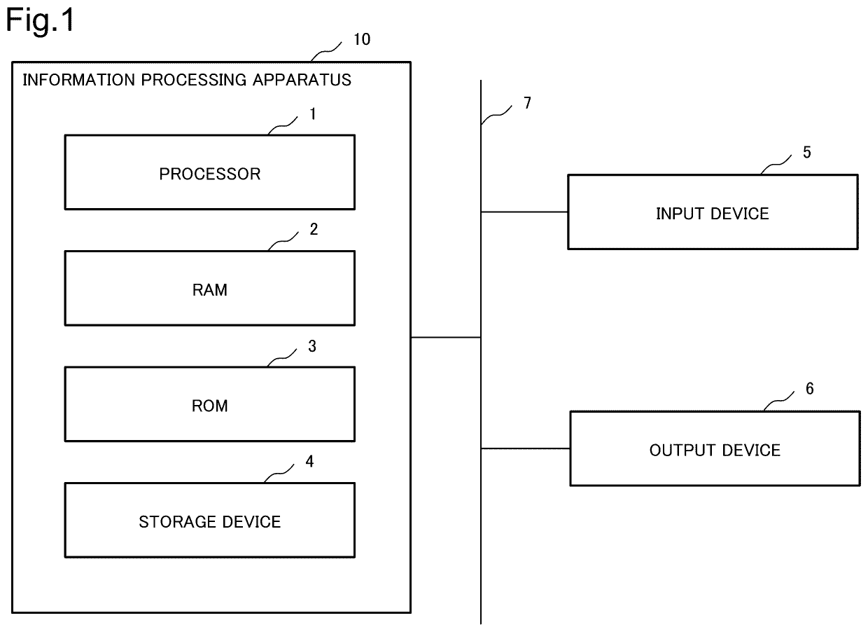

An information processing apparatus 10 and a camera 11 and a display unit 103 that function in conjunction with the information processing apparatus 10 will be described with reference to FIGS. 1 to 4.

### (Hardware Configuration)

First, a hardware configuration of the information processing apparatus 10 will be described with reference to FIG. 1.

FIG. 1 is a block diagram illustrating a hardware configuration of the information processing apparatus 10.

As illustrated in FIG. 1, the information processing apparatus 10 includes a processor 1, a random access memory (RAM) 2, a read only memory (ROM) 3, and a storage device 4. The information processing apparatus 10 is connected to an input device 5 and an output device 6 via a data bus 7.

The processor 1 reads a computer program. For example, the processor 1 is configured to read a computer program stored in at least one of the RAM 2, the ROM 3, and the storage device 4. Alternatively, the processor 1 may read a computer program stored in a computer-readable storage medium using a storage medium reading device (not illustrated). The processor 1 may acquire (or read) the computer program from a device (not illustrated) arranged outside the information processing apparatus 10 via a network interface. The processor 1 controls the RAM 2, the storage device 4, the input device 5, and the output device 6 by executing the read computer program.

In the present example embodiment, in particular, the processor 1 executes the read computer program, and a functional block for performing camera calibration is then achieved in the processor 1. As an example, the functional block may be a calibration calculation unit 101 or an output unit 102 described later. As the processor 1, one of a central processing unit (CPU), a graphics processing unit (GPU), a field programmable gate array (FPGA), a demand-side platform (DSP), or an application specific integrated circuit (ASIC) may be used, or a plurality of the processors may be used in parallel.

The RAM 2 temporarily stores a computer program executed by the processor 1. The RAM 2 temporarily stores data used by the processor 1 executing the computer program. The RAM 2 may be, for example, a dynamic RAM (D-RAM).

The ROM 3 stores the computer program executed by the processor 1. The ROM 3 may store other fixed data. The ROM 3 may be, for example, a programmable ROM (P-ROM).

The storage device 4 stores data to be stored for a long period of time by the information processing apparatus 10. The storage device 4 may operate as a temporary storage device of the processor 1. The storage device 4 may include, for example, at least one of a hard disk device, a magneto-optical disk device, a solid state drive (SSD), or a disk array device.

The input device 5 is a device that receives an input related to the information processing apparatus 10 from the outside. The input device 5 may include, for example, at least one of a keyboard, a mouse, and a touch panel, or may receive input of media information from an external device such as a camera.

The output device 6 is a device that outputs information regarding the information processing apparatus 10 to the outside. The output device 6 may be, for example, a display device (for example, a display) capable of displaying information regarding the information processing apparatus 10.

### (Functional Configuration)

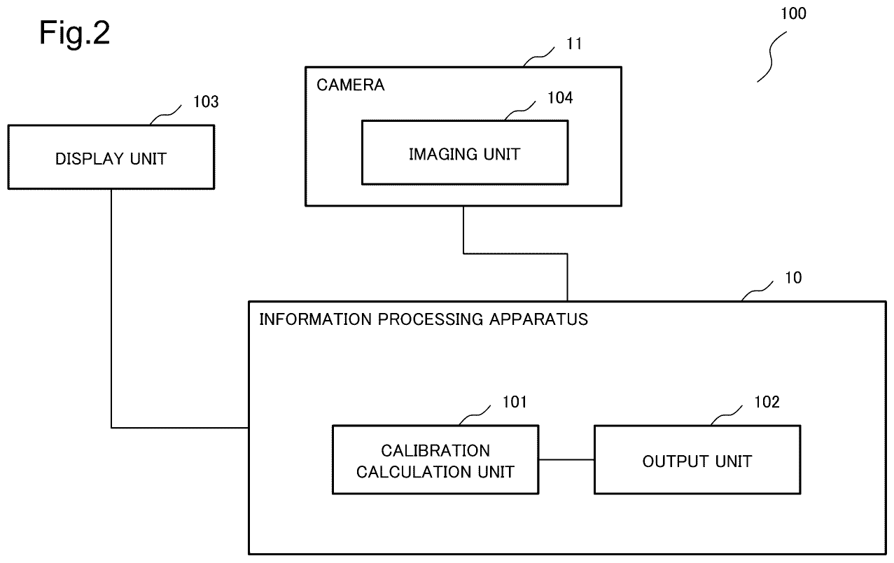

Next, a functional configuration of the information processing apparatus 10 will be described with reference to FIG. 2. FIG. 2 is a block diagram illustrating a functional configuration of an information processing system 100.

As illustrated in FIG. 2, the information processing system 100 includes the information processing apparatus 10, the camera 11, and the display unit 103. The information processing apparatus 10 includes a calibration calculation unit 101 and an output unit 102 as a processing block or a physical processing circuit for achieving the function. Each of the calibration calculation unit 101 and the output unit 102 may be achieved, for example, by the above-described processor 1 reading a program. The camera 11 as the input device 5 and the display unit 103 as the output device 6, which function in conjunction with the information processing apparatus 10, are connected to the information processing apparatus 10. The camera 11 includes an imaging unit 104 and can capture an image.

The calibration calculation unit 101 performs camera calibration using the captured image of the camera 11 that has imaged a planar pattern displayed on the display unit 103. A captured image obtained by capturing an image of the planar pattern by the camera 11 is hereinafter referred to as a first image. The calibration calculation unit 101 performs first calibration by using a correspondence between a feature point position of the planar pattern on the first image and the feature point position of the planar pattern on the world coordinates. The planar pattern may have a known feature point position on the world coordinates and may be a plane. The planar pattern may be displayed by an electronic device such as a display or a projector. The display unit 103 may be an electronic device such as a display or a projector. In a case where the feature point position on the world coordinates is not known, the calibration calculation unit 101 may calculate the feature point position of the planar pattern on the world coordinates using the image data of the planar pattern and the display unit 103.

Specifically, in a case where the display unit 103 is a display, the calibration calculation unit 101 detects the feature point position on the image data of the planar pattern. Thereafter, the calibration calculation unit 101 calculates the feature position of the planar pattern on the world coordinates. The calculation may be performed, for example, based on a feature point position (PIXEL) on the display on which the planar pattern is displayed and a pixel per inch (PPI) of the display. As the planar pattern, a planar or checkered calibration board (for example, CHARUCO BOARD (HTTPS://DOCS. OPENCV. ORG/3.4/DF/D4A/TUTORIAL_CHARUCO_DE TECTION.HTML) or the like) having any pattern may be used. The calibration calculation unit 101 may detect the feature point position of the planar pattern on the first image from the first image by using a feature point detection method (for example, SIFT (scale invariant feature transform) or the like). In a case where the above-described calibration board is used, the calibration calculation unit 101 may detect the feature point position of the planar pattern on the first image using a lattice point detection method included in open source software such as OPENCV (HTTPS://OPENCV.ORG/). In a case where the correspondence between the feature point position on the world coordinates and the feature point position on the first image is unknown, the calibration calculation unit 101 may perform calculation to obtain the correspondence of each feature point. For example, the calibration calculation unit 101 may perform feature point matching based on a feature amount such as SIFT. As a method of camera calibration, a method of calculating internal parameters and external parameters of a camera by geometric calculation (matrix calculation) from a correspondence between a first feature point position of a planar pattern on a first image and a first feature point position of a planar pattern on world coordinates is used. For example, the calibration calculation unit 101 may use a method disclosed in Z.Y. ZHANG., “A FLEXIBLE NEW TECHNIQUE FOR CAMERA CALIBRATION”, IEEE TRANSACTIONS ON PATTERN ANALYSIS AND MACHINE INTELLIGENCE (VOLUME: 22, ISSUE: 11, NOVEMBER 2000, [Searched on Sep. 12, 2024], Internet <URL:https://ieeexplore.ieee.org/document/888718>.

The output unit 102 outputs a deformed pattern obtained by deforming the planar pattern in such a way as to appear to be in front at the viewpoint of the camera 11 based on the parameters calculated by the first calibration by the calibration calculation unit 101. The deformed pattern to be output has the same shape as that when the planar pattern is viewed from the front on the captured image in a case where the planar pattern is captured again by the camera 11 having the same viewpoint position as that when the first image is captured.

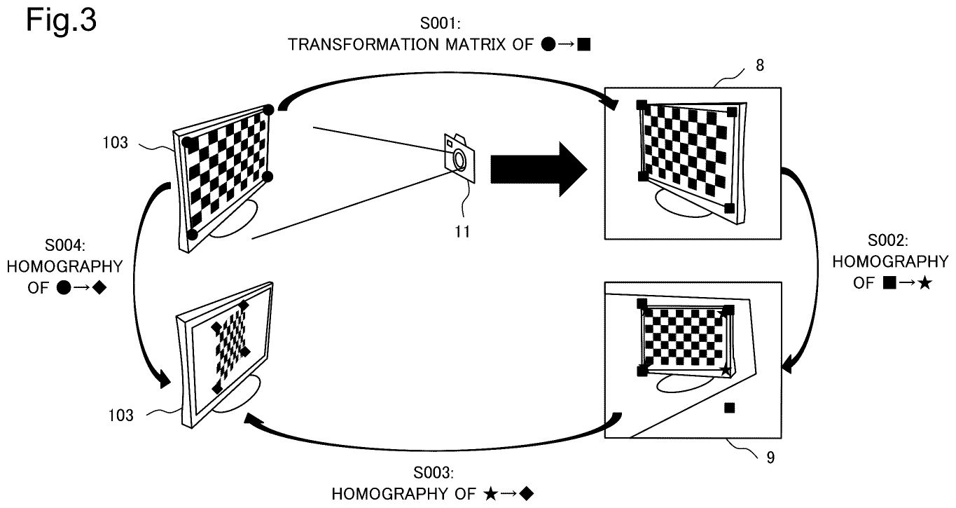

An example of a specific method of deforming the planar pattern will be described with reference to FIG. 3. The modification method described below is an example, and other methods may be used as long as the conversion is such that the planar pattern appears to be in front when viewed from the camera 11. FIG. 3 illustrates deformation processing of the output unit 102 that outputs a deformed pattern in which the planar pattern appears to be in front when viewed from the camera 11 to be calibrated. The output unit 102 outputs the deformed pattern by performing steps S001 to S004. The camera 11 is a camera to be calibrated. The display unit 103 is a display unit that displays a planar pattern or a deformed pattern. The display unit 103 may be an electronic device such as a display or a projector. A first image 8 is the same as the first image described above. A front-facing image 9 is an image that has been subjected to conversion processing in such a way that the planar pattern appears to be in front in a pixel area of the planar pattern appearing in the first image 8.

Each processing of steps S001 to S004 will be described. In step S001, the output unit 102 calculates a matrix (hereinafter, referred to as an H matrix) forming planar homography from each point of the four corners of the planar pattern on the world coordinates displayed on the display unit 103 to each point of four corners of the planar pattern on the first image 8. In step S002, the output unit 102 generates the front-facing image 9 by performing homography such that the planar pattern is projected in front in the pixel area of the planar pattern in the first image 8. An example of the homography will be described. The output unit 102 refers to the image data of the planar pattern displayed on the display unit 103, designates an area having a shape similar to that of the image data in the pixel area of the planar pattern in the first image 8, and performs homography on the area. In step S003, the output unit 102 performs the homography using the inverse matrix of the H matrix on the pixel area of the planar pattern in the front-facing image 9 created in step S002. As a result, a display area of the deformed pattern appearing to be in front when viewed from the camera 11 is obtained. In step S004, the output unit 102 subjects the planar pattern displayed on the display unit 103 to homography in accordance with the display area of the deformed pattern obtained in step S003, thereby creating a deformed pattern in which the planar pattern appears to be in front when viewed from the camera 11.

The output unit 102 has a function of outputting the deformed pattern. The output unit 102 may display the deformed pattern on an electronic device such as a display or a projector. The output unit 102 may output the deformed pattern in such a way as to display the deformed pattern on the display unit 103.

After the output unit 102 outputs the deformed pattern, the camera 11 having the same viewpoint position as that at the time of capturing the first image captures the output deformed pattern. The calibration calculation unit 101 performs the second calibration by using the correspondence between the feature point positions of the deformed pattern on the captured image and the feature point positions of the deformed pattern on the world coordinates. Hereinafter, the captured image of the deformed pattern is referred to as a second image. The deformed pattern is displayed in such a way as to appear to be in front on the second image used for calibration. The method used in the first calibration may be used for the detection of the feature point of the deformed pattern on the second image and the association between the feature point on the world coordinates and the feature point on the second image. As a camera calibration method, a method used in the first calibration may be used. The calibration calculation unit 101 may calculate the fourth feature point position of the deformed pattern on the world coordinates based on the deformation processing of the planar pattern performed by the output unit 102 and the feature point position on the display that displays the deformed pattern. Specifically, after detecting the feature point position on the image data of the planar pattern, the calibration calculation unit 101 obtains the feature point position on the deformed pattern by performing the deformation processing (homography) performed by the output unit 102 on the detected feature point. The calibration calculation unit 101 calculates the feature position of the deformed pattern on the world coordinates based on the feature point position (PIXEL) on the display on which the deformed pattern is displayed and the PPI of the display.

### (Flow of Operation)

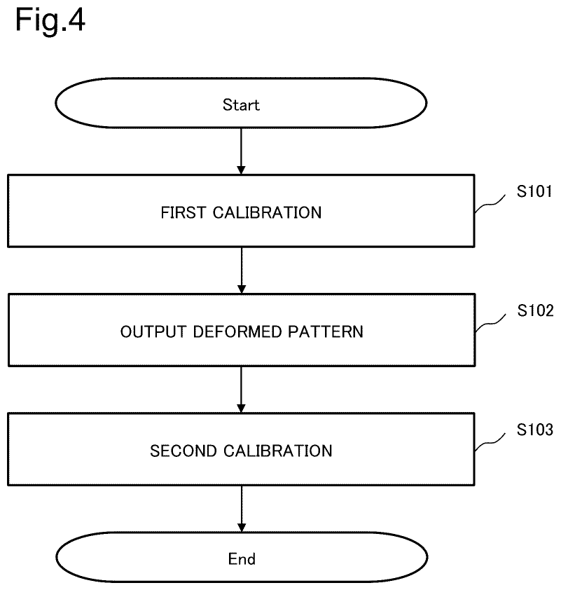

A flow of the operation of the information processing apparatus 10 will be described with reference to FIG. 4. FIG. 4 is a flowchart illustrating a flow of operation of the information processing apparatus.

Steps S101 to S103 will be described. In step S101, the calibration calculation unit 101 performs the first calibration. Specifically, the calibration calculation unit 101 performs the first camera calibration using the captured image of the planar pattern displayed on the display unit 103 by the camera 11. Thereafter, in step S102, the output unit 102 outputs a deformed pattern obtained by deforming the planar pattern in such a way as to appear to be in front at the viewpoint of the camera 11 based on the parameters calculated by the first calibration. Finally, in step S103, the calibration calculation unit 101 performs the second calibration, and the operation of the information processing apparatus ends (End). The second calibration is performed by the camera 11 imaging the deformed pattern output in step S102 and the calibration calculation unit 101 using the captured deformed pattern.

### (Technical Effects)

Next, technical effects obtained by the information processing apparatus 10 will be described.

As described with reference to FIGS. 1 to 4, since the camera can image the deformed pattern in the second image from the front, the feature point detection accuracy of the deformed pattern on the second image can be improved. As a result, since a more precise feature point position can be used for calibration, the information processing apparatus 10 can improve the parameter estimation accuracy in the calibration.

### Second Example Embodiment

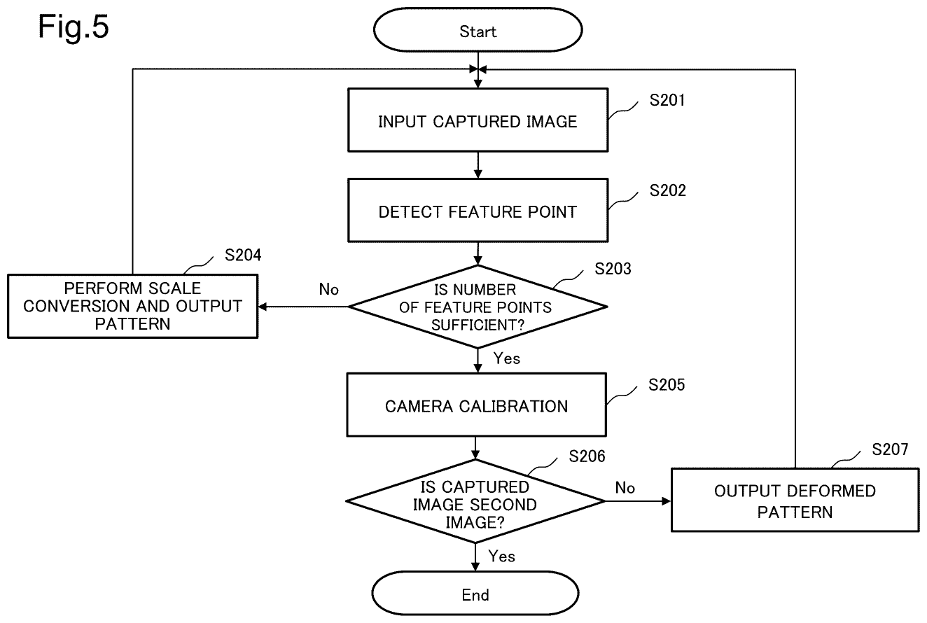

Another example of the operation of the information processing apparatus 10 will be described with reference to FIG. 5. A hardware configuration and a functional configuration of an information processing apparatus 10 according to a second example embodiment may be similar to those of the first example embodiment. In the following example embodiments, portions different from those of the first example embodiment will be described in detail, and description of overlapping portions will be omitted as appropriate.

### (Flow of Operation)

First, an operation flow of the information processing apparatus 10 will be described with reference to FIG. 5. FIG. 5 is a flowchart illustrating a flow of operation of the information processing apparatus 10.

Steps S201 to S207 will be described. In step S201, the calibration calculation unit 101 receives the captured image of the planar pattern or the deformed pattern displayed on the display unit 103 by the camera 11. In step S201 to be performed first, the input captured image of the planar pattern is input as a first image, and the captured image of the deformed pattern output in step S207 to be described later is input as a second image. Next, in step S202, the calibration calculation unit 101 detects a feature point of a planar pattern or a deformed pattern on the captured image. In step S203, the calibration calculation unit 101 determines whether the number of feature points detected in step S202 is equal to or more than the number of feature points (that is, the minimum number required to execute the calibration algorithm) sufficient for performing camera calibration in step S204. As a result of the determination, in a case where it is determined that the number of feature points is sufficient (Yes), the processing proceeds to step S205, and in a case where it is determined that the number of feature points is not sufficient (No), the processing proceeds to step S204. In step S204, the output unit 102 performs scale conversion on the planar pattern or the deformed pattern and outputs the planar pattern or the deformed pattern in such a way that the entire deformed pattern is displayed maximally in the display area in the display area where the deformed pattern is to be displayed. The output unit 102 performs scale conversion in such a way that the size of an area for displaying the planar pattern changes while maintaining the shape in an area for displaying the planar pattern or the deformed pattern. The output planar pattern or deformed pattern is displayed on the display unit 103, and the processing proceeds to step S201 again.

In step S205, the calibration calculation unit 101 performs camera calibration based on the feature point position of the planar pattern or the deformed pattern on the captured image detected in step S202 and the feature point position of the planar pattern or the deformed pattern on the world coordinates. The camera calibration is either the first camera calibration or the second camera calibration described above. In step S206, the calibration calculation unit 101 determines whether the captured image input in step S201 is the second image. As a result of the determination, in a case where it is determined that the captured image is the second image (Yes), the operation is ended by the output unit 102 outputting the camera parameters calculated by the camera calibration (that is, the second camera calibration) in step S205 as a final processing result (End), and in a case where it is determined that the captured image is not the second image (that is, the image is the first image) (No), the processing proceeds to step S207. In step S207, the output unit 102 outputs the deformed pattern appearing to be in front of the camera 11 based on the result of the camera calibration (that is, the first camera calibration) performed in step S205. Thereafter, the processing proceeds to step S201 again, and the calibration calculation unit 101 acquires the captured image (that is, the second image) of the deformed pattern.

### (Technical Effects)

Next, technical effects obtained by the information processing apparatus 10 will be described.

As described with reference to FIG. 5, the information processing apparatus 10 can output the scale-converted planar pattern or deformed pattern even in a case where a feature point sufficient for performing camera calibration cannot be detected in the captured image. As a result, even in a case where it is difficult to perform camera calibration, the information processing apparatus 10 can perform camera calibration.

### Third Example Embodiment

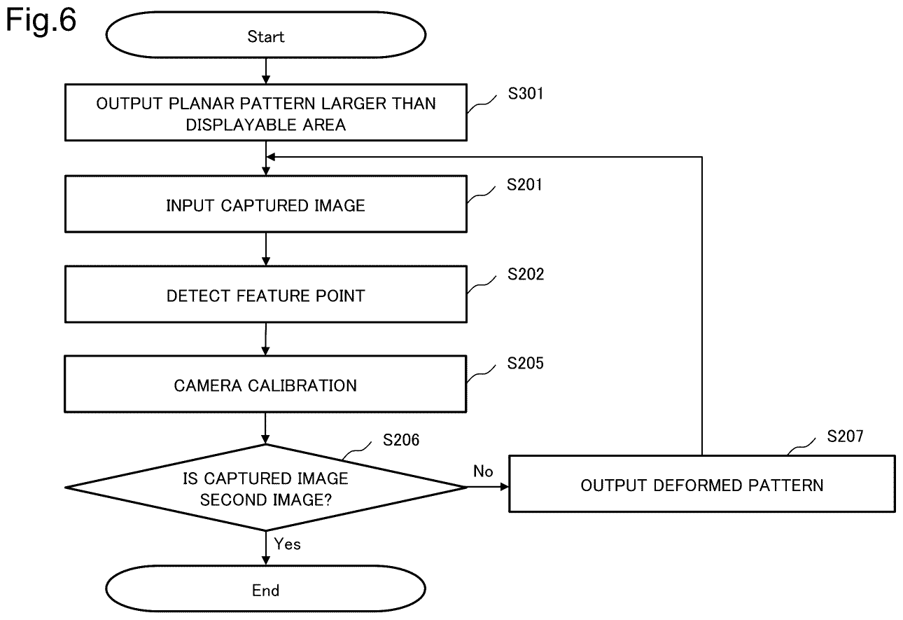

Another example of the operation of the information processing apparatus 10 will be described with reference to FIG. 6. A hardware configuration and a functional configuration of the information processing apparatus 10 may be similar to those of the first example embodiment. Steps common to those in FIG. 5 are denoted by the same reference numerals, and description thereof is omitted as appropriate.

### (Flow of Operation)

First, an operation flow of the information processing apparatus 10 will be described with reference to FIG. 6. FIG. 6 is a flowchart illustrating a flow of operation of the information processing apparatus 10. The flowchart illustrated in FIG. 6 is different from the flowchart of FIG. 5 in that steps S203 and S204 are omitted and step S301 is included.

Step S301 will be described. Step S301 is processing performed by the output unit 102. In step S301, the output unit 102 outputs the planar pattern of a first size larger than a displayable area of the display unit 103. The output planar pattern is displayed in the entire display area of the display unit 103. On the display unit 103, a part of the planar pattern is displayed over the entire displayable area.

Steps after step S301 are similar to the flowchart of FIG. 5 without steps S203 and S204. A difference from FIG. 5 due to step S301 will be described. In step S207 performed after step S301, in a case where the deformation processing as shown in step S004 of FIG. 3 is performed, the planar pattern outside the display area appears in the display area. As a result, the deformed pattern can be displayed in a wider area on the display unit 103.

### (Technical Effects)

Next, technical effects obtained by the information processing apparatus 10 will be described with reference to FIGS. 3 and 6.

In a case where the deformation processing as shown in step S004 of FIG. 3 is performed, the display area of the planar pattern changes between the planar pattern and the deformed pattern. In other words, the display area of the planar pattern on the display unit 103 may be reduced by the deformation processing. On the other hand, a part of the planar pattern larger than the displayable area of the display unit 103 is displayed in advance on the entire display unit 103, which makes it possible to reduce an influence of reducing the display area of the planar pattern by the planar pattern outside the display area appearing in the display area when the deformation processing is performed. As a result, the information processing apparatus 10 can provide a display state of a pattern in which feature points are easily detected, and can improve accuracy of camera calibration.

### Fourth Example Embodiment

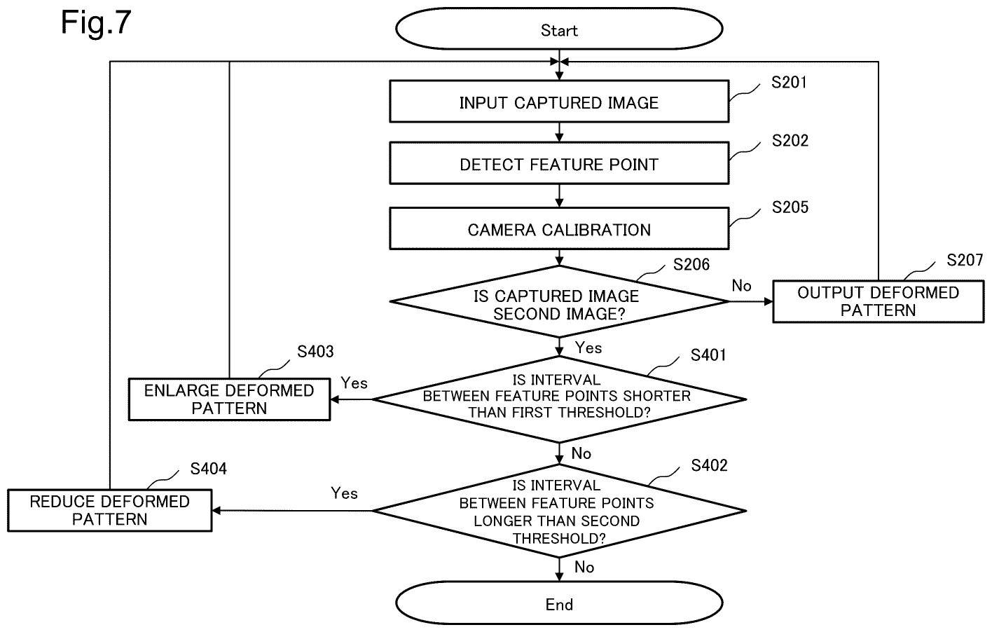

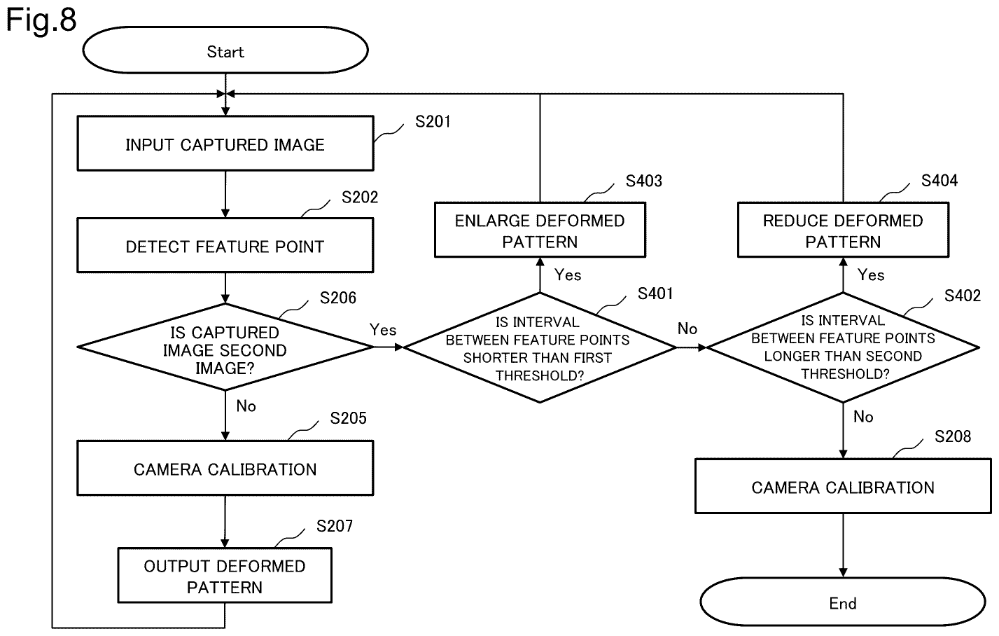

Another example of the operation of the information processing apparatus 10 will be described with reference to FIGS. 7 and 8. A hardware configuration and a functional configuration of the information processing apparatus 10 may be similar to those of the first example embodiment. Steps common to those in FIG. 5 are denoted by the same reference numerals, and description thereof is omitted as appropriate.

### (Flow of Operation)

FIGS. 7 and 8 illustrate a flow of the operation of the fourth example embodiment in which the processing order is different. First, a first example of an operation flow of the information processing apparatus 10 will be described with reference to FIG. 7. FIG. 7 is a flowchart illustrating a flow of operation of the information processing apparatus 10. Steps common to FIGS. 5 and 6 are denoted by the same reference numerals, and description thereof is omitted as appropriate. The flowchart illustrated in FIG. 7 is different from FIG. 5 in that steps S203 and S204 are omitted and steps S401 to S404 are included.

Steps S401 to S404 will be described. Steps S401 to S404 are performed in a case where it is determined in step S206 that the captured image is the second image (Yes). In step S401, the calibration calculation unit 101 determines whether an interval between the feature points of the deformed pattern on the second image detected in step S202 is shorter than a first threshold. The interval between the feature points may be, for example, a total value or an average value of Euclidean distances of the feature points on the second image. Any value may be set as the first threshold as long as the value is smaller than a second threshold to be described later. As a result of the determination in step S401, in a case where it is determined that the interval between the feature points is shorter than the first threshold, the processing proceeds to step S403 (Yes), and otherwise, the processing proceeds to step S402 (No). In step S402, the calibration calculation unit 101 determines whether the interval between the feature points of the deformed pattern on the second image detected in step S202 is longer than a second threshold. An example of the interval between the feature points is as described above. Any value may be set as the second threshold as long as the value is larger than the first threshold. As a result of the determination in step S402, in a case where it is determined that the interval is longer than the second threshold, the processing proceeds to step S404 (Yes), and otherwise, the processing is ended (No). In step S403, the output unit 102 performs scale conversion processing of enlarging the deformed pattern output in step S207, and outputs the deformed pattern subjected to scale conversion. In step S404, the output unit 102 performs scale conversion processing of reducing the deformed pattern output in step S207, and outputs the deformed pattern subjected to scale conversion. After the scale conversion processing of enlarging or reducing the deformed pattern is performed in step S403 or S404, the processing proceeds to step S201, the second calibration is performed by reacquiring the second image, and the processing is repeated until NO is determined in both steps S401 and S402.

A second example of the flow of the operation of the information processing apparatus 10 will be described with reference to FIG. 8. In the step of the flowchart of FIG. 8, processing similar to the step of the flowchart of FIG. 7 is executed. However, the flowchart of FIG. 8 is different from the flowchart of FIG. 7 in that whether the captured image in step S206 is the second image is determined before the execution of the camera calibration in step S205. In a case where the calibration calculation unit 101 determines in step S206 that the captured image is the second image (Yes), the processing proceeds to step S401, and in a case where the calibration calculation unit 101 determines that the captured image is not the second image (No), the processing proceeds to step S205. The flowchart of FIG. 8 is also different from the flowchart of FIG. 7 in that, in a case where it is determined in step S402 that the interval between the feature points is not longer than the second threshold (No), camera calibration similar to that in step S205 is performed in step S208. In a case where the result of the determination in both steps S401 and S402 is NO, camera calibration in step S208 is performed, and the operation ends.

### (Technical Effects)

Next, technical effects obtained by the information processing apparatus 10 will be described.

As described with reference to FIGS. 7 to 8, the information processing apparatus 10 has a function of enlarging and outputting the deformed pattern in a case where the interval between the feature points on the second image is shorter than the first threshold, and reducing and outputting the deformed pattern in a case where the interval is longer than the second threshold. The information processing apparatus 10 performs the determination performed in steps S401 and S402 and steps S403 and S404 for executing the enlargement/reduction processing associated to each, and therefore the detection accuracy of the feature point is improved when the feature point is detected again in step S202. Therefore, the information processing apparatus 10 has an effect of performing camera calibration with high accuracy. For example, it is assumed that the information processing apparatus 10 performs the camera calibration in step S205 using a checkered calibration board. At this time, it is conceivable that the interval between the lattice points (feature points) detected on the captured image becomes equal to or less than the threshold because the calibration board is too far from the camera 11, and the feature point position cannot be accurately detected. In such a case, the information processing apparatus 10 enlarges and displays the deformed pattern on the display unit 103, thereby enabling accurate feature point detection, and thereby enabling highly accurate calibration. Similarly, it is conceivable that due to the influence that the calibration board is too close to the camera 11, the interval between the lattice points (feature points) detected on the captured image becomes equal to or more than the threshold, and the feature point position cannot be accurately detected. In such a case, the information processing apparatus 10 reduces and displays the deformed pattern on the display unit 103, thereby enabling accurate feature point detection, and thereby enabling highly accurate calibration.

### Fifth Example Embodiment

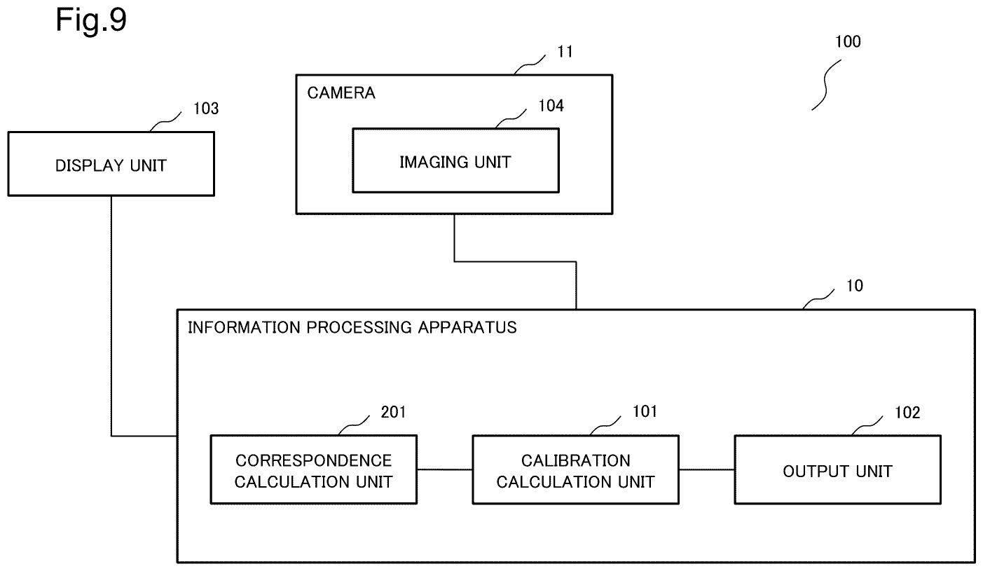

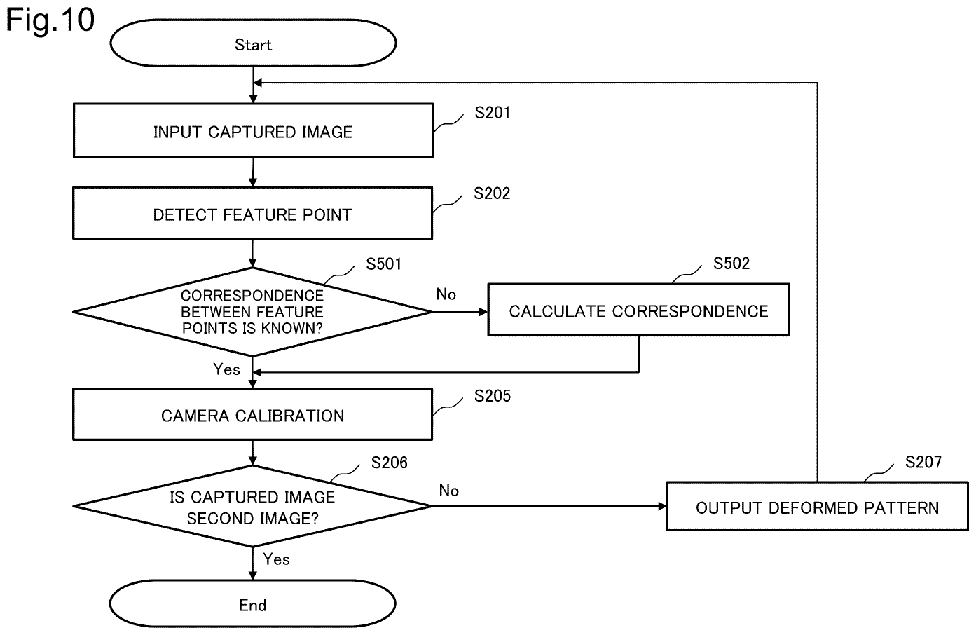

Another example of the operation of the information processing apparatus 10 will be described with reference to FIGS. 9 and 10. Hereinafter, portions different from those of the first example embodiment will be described in detail, and description of overlapping portions will be omitted as appropriate.

### (Functional Configuration)

A functional configuration of the information processing apparatus 10 will be described with reference to FIGS. 9 and 10.

FIG. 9 is a block diagram illustrating a functional configuration of the information processing system 100.

FIG. 9 is different from FIG. 2 in that the information processing apparatus 10 further includes a correspondence calculation unit 201. The correspondence calculation unit 201 may be implemented by the above-described processor 1 reading a program.

The correspondence calculation unit 201 calculates the association in a case where the first correspondence, which is a positional relationship between the feature point position of the planar pattern on the first image and the feature point position of the planar pattern on the world coordinates, is not set. An example of specific association will be described. First, the correspondence calculation unit 201 performs feature point detection and feature amount calculation on the first image that is the captured image. As a method of feature point detection and feature amount calculation, for example, a method capable of feature point matching such as SIFT may be used. Next, the correspondence calculation unit 201 performs similar feature point detection and feature amount calculation on the image data of the planar pattern displayed on the display unit 103. Thereafter, the correspondence calculation unit 201 performs matching between the feature point detected on the first image and the feature point detected on the image data of the planar pattern, and extracts a feature point having a correspondence. Finally, the correspondence calculation unit 201 acquires the feature point position of the planar pattern on the world coordinates by calculating at which position the feature point position, which is on the image data of the planar pattern and for which the correspondence is specified by the matching, is displayed when the planar pattern is displayed on the display unit 103. Specifically, for example, in a case where the display unit 103 is a display, the correspondence calculation unit 201 calculates the feature position of the planar pattern on the world coordinates based on the feature point position (PIXEL) on the display displaying the planar pattern and the pixel per inch (PPI) of the display.

The correspondence calculation unit 201 can calculate the association even in a case where a second correspondence that is a positional relationship between the feature point position of the deformed pattern on the second image and the fourth feature point position of the deformed pattern on the world coordinates is not set. For specific association processing, the correspondence calculation unit 201 may use a method similar to the calculation of association between the feature point position of the planar pattern on the first image and the feature point position of the planar pattern on the world coordinates.

### (Flow of Operation)

A flow of the operation of the information processing apparatus 10 will be described with reference to FIG. 10. FIG. 10 is a flowchart illustrating a flow of operation of the information processing apparatus. Steps common to those in FIG. 5 are denoted by the same reference numerals, and description thereof is omitted as appropriate. The flowchart illustrated in FIG. 10 is different from that in FIG. 5 in that steps S203 and S204 are not included but steps S501 and S502 are included.

Steps S501 and S502 will be described. Steps S501 and S502 are processing performed by the correspondence calculation unit 201. Step S501 is performed after step S202. In step S501, the correspondence calculation unit 201 determines whether the feature point position of the planar pattern in the first image or the deformed pattern in the second image and the associated feature point position of the planar pattern or the deformed pattern on the world coordinates are associated with each other. As a result of the determination, in a case where it is determined that both are associated with each other (Yes), the processing proceeds to step S205, and in a case where it is determined that both are not associated with each other (No), the processing proceeds to step S502. In step S502, the correspondence calculation unit 201 performs calculation of associating the feature point position of the planar pattern in the first image or the deformed pattern in the second image with the feature point position of the planar pattern or the deformed pattern on the world coordinates associated thereto. Thereafter, the processing proceeds to step S205. After step S205, in step S206, in a case where the calibration calculation unit 101 determines that the captured image is the second image (Yes), the operation ends. On the other hand, in step S206, in a case where the calibration calculation unit 101 determines that the captured image is the first image (No), the calibration calculation unit 101 performs the processing of step S207. After step S207, the processing returns to step S201, and steps S201, S202, and S501 are performed in this order. For each processing after the processing proceeds to step S501 again, processing similar to each processing described in this paragraph is performed.

### (Technical Effects)

Next, technical effects obtained by the information processing apparatus 10 will be described.

As described with reference to FIGS. 9 to 10, the information processing apparatus 10 has a function of associating the feature point position of the planar pattern in the first image or the deformed pattern in the second image with the associated feature point position of the planar pattern or the deformed pattern on the world coordinates. As a result, the information processing apparatus 10 has an effect of enabling camera calibration using any planar pattern.

### Sixth Example Embodiment

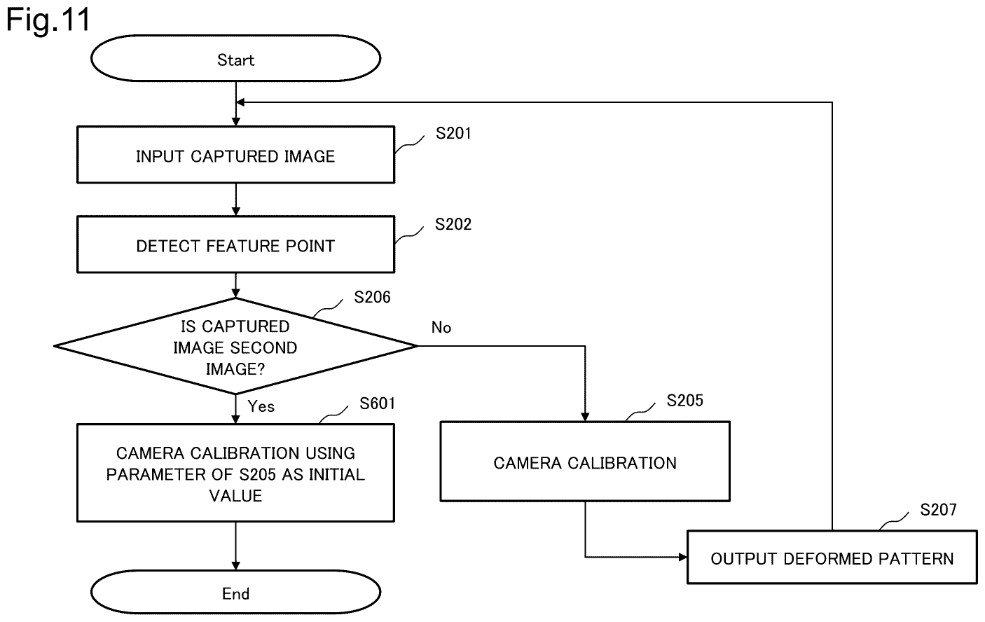

Another example of the operation of the information processing apparatus 10 will be described with reference to FIG. 11. A hardware configuration and a functional configuration of an information processing apparatus 10 may be similar to those of the first example embodiment.

Hereinafter, portions different from those of the first example embodiment will be described in detail, and description of overlapping portions will be omitted as appropriate.

### (Flow of Operation)

A flow of the operation of the information processing apparatus 10 will be described with reference to FIG. 11. FIG. 11 is a flowchart illustrating a flow of operation of the information processing apparatus 10. The same reference numerals are given to steps that perform the same processing as in FIG. 5. The flowchart illustrated in FIG. 11 is different from the flowchart in FIG. 5 in that steps S203 and S204 are not included but step S601 is included, and step S206 for determining whether the captured image is the second image is performed before the camera calibration in step S205. In FIG. 11, processing of each step common to that in FIG. 5 is similar to that in FIG. 5.

Step S601 will be described. Step S601 is performed by the calibration calculation unit 101 in a case where it is determined in step S206 that the captured image is the second image (Yes). Here, the calibration calculation unit 101 further performs camera calibration (second calibration) by using the camera parameters obtained by the camera calibration (first calibration) in step S103 as initial values of the calculated camera parameters. That is, the calibration calculation unit 101 of the information processing apparatus 10 uses the parameter calculated by the first calibration as the initial value of the parameter of the camera to be estimated when the output unit 102 performs the second calibration after outputting the deformed pattern.

### (Technical Effects)

Next, technical effects obtained by the information processing apparatus 10 will be described.

As described with reference to FIG. 11, the information processing apparatus 10 uses the camera parameter calculated by the first calibration as the initial value of the parameter calculated by the second camera calibration. As a result, the estimation accuracy of the camera parameters calculated by the camera calibration is improved.

### Supplementary Note

The example embodiments described above can be further described as follows, but is not limited thereto.

### (Supplementary Note 1)

An information processing apparatus including a calibration calculation unit that performs first calibration of a camera based on a first feature point position of a planar pattern included in a first image captured by the camera and a second feature point position of the planar pattern on world coordinates, and an output unit that outputs, based on the first calibration, a deformed pattern obtained by deforming the planar pattern in such a way that the deformed pattern appears on a second image captured by the camera as if the camera were facing the planar pattern, in which the calibration calculation unit acquires the second image of the deformed pattern captured by the camera, and performs second calibration of the camera based on a third feature point position of the deformed pattern in the second image and a fourth feature point position of the deformed pattern on the world coordinates.

### (Supplementary Note 2)

The information processing apparatus according to Supplementary Note 1, in which the output unit performs an output in such a way that, in a case where the calibration calculation unit cannot detect a feature point on the first image necessary for performing the first calibration, the planar pattern in which scale conversion has been performed on the planar pattern displayed at the time of capturing the first image by the camera is displayed in a display area capable of displaying the planar pattern, and the calibration calculation unit performs the first calibration by using the feature point position of the planar pattern subjected to scale conversion included in the first image captured by the camera.

### (Supplementary Note 3)

The information processing apparatus according to Supplementary Note 1 or 2, in which the output unit performs an output in such a way that, in a case where the calibration calculation unit cannot detect a feature point on the second image necessary for performing the second calibration, the deformed pattern in which scale conversion has been performed on the deformed pattern displayed at the time of capturing the second image by the camera is displayed in a display area capable of displaying the deformed pattern, and the calibration calculation unit performs the second calibration by using the feature point position of the deformed pattern subjected to scale conversion included in the second image captured by the camera.

(supplementary Note 4)

The information processing apparatus according to any one of Supplementary Notes 1 to 3, in which the output unit performs scale conversion on the deformed pattern in such a way that the entire deformed pattern is maximally displayed in the display area, in the display area where the deformed pattern is displayed, and outputs the deformed pattern subjected to scale conversion.

(supplementary Note 5)

The information processing apparatus according to any one of Supplementary Notes 1 to 4, in which the output unit causes the planar pattern having a first size larger than that of the display area to be displayed over the entire display area in the display area where the planar pattern is to be displayed, and the calibration calculation unit performs the first calibration using the first image including the planar pattern of the first size, the first image being captured by the camera.

### (Supplementary Note 6)

The information processing apparatus according to any one of Supplementary Notes 1 to 5, in which the calibration calculation unit performs the second calibration by causing the output unit to output an enlarged deformed pattern and then reacquiring the second image in a case where an interval between the feature points detected on the second image is shorter than a first threshold, the calibration calculation unit performs the second calibration by causing the output unit to output a reduced deformed pattern and then reacquiring the second image in a case where the interval between the feature points detected on the second image is longer than a second threshold, and the second threshold is larger than the first threshold.

### (Supplementary Note 7)

The information processing apparatus according to any one of Supplementary Notes 1 to 6, further including a correspondence calculation unit that calculates at least one of a first correspondence or a second correspondence in at least one of a case where the first correspondence that is a correspondence between the feature point position of the planar pattern in the first image and the feature point position of the planar pattern on the world coordinates is not set and a case where the second correspondence that is a correspondence between the third feature point position of the deformed pattern in the second image and the fourth feature point position of the deformed pattern on the world coordinates is not set.

### (Supplementary Note 8)

The information processing apparatus according to any one of Supplementary Notes 1 to 7, in which the calibration calculation unit uses a parameter calculated by the first calibration as an initial value of the parameter of the camera to be estimated in a case where the output unit performs the second calibration after outputting the deformed pattern.

### (Supplementary Note 9)

A method executed by an information processing apparatus including performing first calibration of a camera based on a first feature point position of a planar pattern included in a first image captured by the camera and a second feature point position of the planar pattern on world coordinates; outputting, based on the first calibration, a deformed pattern obtained by deforming the planar pattern in such a way that the deformed pattern appears on a second image captured by the camera as if the camera were facing the planar pattern; acquiring the second image of the deformed pattern captured by the camera; and performing second calibration of the camera based on a third feature point position of the deformed pattern in the second image and a fourth feature point position of the deformed pattern on the world coordinates.

### (Supplementary Note 10)

A program for causing a computer to execute: performing first calibration of a camera based on a first feature point position of a planar pattern included in a first image captured by the camera and a second feature point position of the planar pattern on world coordinates; outputting, based on the first calibration, a deformed pattern obtained by deforming the planar pattern in such a way that the deformed pattern appears on a second image captured by the camera as if the camera were facing the planar pattern; acquiring the second image of the deformed pattern captured by the camera; and performing second calibration of the camera based on a third feature point position of the deformed pattern in the second image and a fourth feature point position of the deformed pattern on the world coordinates.

Some or all of the configurations described in Supplementary Notes 2 to 8 dependent on the information processing apparatus of Supplementary Note 1 described above can also be dependent on Supplementary Note 9 (method) and Supplementary Note 10 (program) by the same dependency relationship as Supplementary Notes 2 to 8. Not only Supplementary Notes 1 to 8, Supplementary Note 9, and Supplementary Note 10, but also various recording means or systems for recording various hardware, software, and software can be similarly dependent on some or all of the configurations described as Supplementary Notes without departing from the above-described example embodiments.

This disclosure can be appropriately modified without departing from the gist or idea of the invention that can be read from the claims and the entire specification, and an information processing apparatus, an information processing method, and a program accompanied by such modification are also included in the technical idea of this disclosure.

Each example embodiment can be appropriately combined with other example embodiments. The present disclosure is not limited by the described example embodiments.

This application is based upon and claims the benefit of priority from Japanese patent application No. 2024-163228, filed on Sep. 20, 2024, the disclosure of which is incorporated herein in its entirety by reference.

1. An information processing apparatus comprising:
at least one memory configured to store instructions; and
at least one processor configured to execute the instructions to:
perform first calibration of a camera based on a first feature point position of a planar pattern included in a first image captured by the camera and a second feature point position of the planar pattern on world coordinates; and
output, based on the first calibration, a deformed pattern obtained by deforming the planar pattern in such a way that the deformed pattern appears on a second image captured by the camera as if the camera were facing the planar pattern,
wherein the at least one processor is configured to execute the instructions to acquire the second image of the deformed pattern captured by the camera, and to perform second calibration of the camera based on a third feature point position of the deformed pattern in the second image and a fourth feature point position of the deformed pattern on the world coordinates.

2. The information processing apparatus according to claim 1, wherein
the at least one processor is configured to execute the instructions to:
perform an output in such a way that, in a case where a feature point on the first image necessary for performing the first calibration cannot be detected, the planar pattern in which scale conversion has been performed on the planar pattern displayed at the time of capturing the first image by the camera is displayed in a display area capable of displaying the planar pattern, and
perform the first calibration by using the first feature point position of the planar pattern subjected to scale conversion included in the first image captured by the camera.

3. The information processing apparatus according to claim 1, wherein
the at least one processor is configured to execute the instructions to:
perform an output in such a way that, in a case where a feature point on the second image necessary for performing the second calibration cannot be detected, the deformed pattern in which scale conversion has been performed on the deformed pattern displayed at the time of capturing the second image by the camera is displayed in a display area capable of displaying the deformed pattern, and
perform the second calibration by using the third feature point position of the deformed pattern subjected to scale conversion included in the second image captured by the camera.

4. The information processing apparatus according to claim 1, wherein
the at least one processor is configured to execute the instructions to:
perform scale conversion on the deformed pattern in such a way that the entire deformed pattern is maximally displayed in the display area, in the display area where the deformed pattern is displayed, and outputs the deformed pattern subjected to scale conversion.

5. The information processing apparatus according to claim 1, wherein
the at least one processor is configured to execute the instructions to:
cause the planar pattern having a first size larger than that of the display area to be displayed over the entire display area in the display area where the planar pattern is to be displayed, and
perform the first calibration using the first image including the planar pattern of the first size, the first image being captured by the camera.

6. The information processing apparatus according to claim 1, wherein
the at least one processor is configured to execute the instructions to:
perform the second calibration by outputting an enlarged deformed pattern and then reacquiring the second image in a case where an interval between feature points detected on the second image is shorter than a first threshold,
perform the second calibration by outputting a reduced deformed pattern and then reacquiring the second image in a case where the interval between the feature points detected on the second image is longer than a second threshold, and
the second threshold is larger than the first threshold.

7. The information processing apparatus according to claim 1, wherein
the at least one processor is further configured to execute the instructions to:
calculate at least one of a first correspondence or a second correspondence in at least one of a case where the first correspondence that is a correspondence between the first feature point position of the planar pattern in the first image and the second feature point position of the planar pattern on the world coordinates is not set and a case where the second correspondence that is a correspondence between the third feature point position of the deformed pattern in the second image and the fourth feature point position of the deformed pattern on the world coordinates is not set.

8. The information processing apparatus according to claim 1, wherein
the at least one processor is configured to execute the instructions to:
use a parameter calculated by the first calibration as an initial value of the parameter of the camera to be estimated in a case where the second calibration after outputting the deformed pattern is performed.

9. A method executed by an information processing apparatus comprising:
performing first calibration of a camera based on a first feature point position of a planar pattern included in a first image captured by the camera and a second feature point position of the planar pattern on world coordinates;
outputting, based on the first calibration, a deformed pattern obtained by deforming the planar pattern in such a way that the deformed pattern appears on a second image captured by the camera as if the camera were facing the planar pattern;
acquiring the second image of the deformed pattern captured by the camera; and
performing second calibration of the camera based on a third feature point position of the deformed pattern in the second image and a fourth feature point position of the deformed pattern on the world coordinates.

10. A non-transitory recording medium storing a program for causing a computer to execute:
performing first calibration of a camera based on a first feature point position of a planar pattern included in a first image captured by the camera and a second feature point position of the planar pattern on world coordinates;
outputting, based on the first calibration, a deformed pattern obtained by deforming the planar pattern in such a way that the deformed pattern appears on a second image captured by the camera as if the camera were facing the planar pattern;
acquiring the second image of the deformed pattern captured by the camera; and
performing second calibration of the camera based on a third feature point position of the deformed pattern in the second image and a fourth feature point position of the deformed pattern on the world coordinates.
